(19) United States
(12) Patent Application Publication
(10) Pub. No.: US 2005/0266159 A1
(43) Pub. Date: Dec. 1, 2005

(54) Method for improving birefringence of optical film

(75) Inventors: Kuang-Rong Lee, Taoyuan (TW); Tan-Ching Wang, Taoyuan (TW); Hung-Yuan Lin, Taoyuan (TW); Bor-Ping Wang, Taoyuan (TW)

Correspondence Address: NIKOLAI & MERSEREAU, P.A., 900 SECOND AVENUE SOUTH, SUITE 820, MINNEAPOLIS, MN, 55402, US

(73) Assignee: OPTIMAX TECHNOLOGY CORPORATION, Taoyuan (TW)

(21) Appl. No.: 10/993,293

(22) Filed: Nov. 19, 2004

(30) Foreign Application Priority Data
Jun. 1, 2004 (TW) 093115716

(51) Int. Cl. G02F 1/1335

(52) U.S. Cl. 427/162

(57) ABSTRACT

The present invention relates to a method for improving birefringence of an optical film. The birefringence may be optically positive one and negative one. The method includes adding nano-particles into a polymer in accordance with a process of solution casting to prepare an optical hybrid film of high birefringence. The method of the present invention includes the steps of dissolving, knife coating, drying, heating and stretching a film. The optical hybrid film is useful in retardation film in a liquid crystal display.

### BACKGROUND OF THE INVENTION

(1) Field of the Invention

The present invention relates to a method for improving the birefringence of an optical film. The birefringence may be optionally positive or negative. The method includes adding nano-particles into a polymer in accordance with a process of solution casting to prepare an optical hybrid film of high birefringence. The hybrid film is useful in phase compensation device in a LCD (Liquid Crystal Display).

(2) Description of the Prior Art

Since the recent one decade, a trend toward lightness, thin size, power-saving character and low radiation is the main target of the industry of computer-relating appliance and therefore contributes to the development of the optoelectronics field. However, traditional CRT (cathode ray tube) is out of date due to its huge volume, heavy weight and radiation problems. Therefore, attention has recently been drawn to LCD (liquid crystal display) that is advantageous over the CRT one for comparatively low power consumption, energy-saving feature, being easier to carry around, higher resolution, and unnoticeable time-lapse of pictures. The LCD accordingly becomes the ideal and promising display in the 21^{st} century.

Contrast, repetition of color and stable intensity of gray scale are the important characters of the LCD. The main factor of limiting the contrast of the LCD is the tendency of leakage of light emitting from the LCD, which displays dark or black pixels on screen, a.k.a. “ghosting.” Colors may also mix with each other and twist the original images when leakage happens. Moreover, the leakage is related to the view angle with respect to the LCD and the perfect contrast lies within a narrow range of view angle of perpendicular incidence. When the view angle increases, the contrast drops rapidly.

In view of the above description, it is understood that narrow view angle and chromatic aberration are present problems to be solved, especially the view angle one is getting more and more serious since the display size is increasingly large. The current solutions for the view angle problem are improvements for inner and outer liquid crystal boxes. The former is, for example, fractional pixels, multi-domain technique or novel display method of IPS (in plane switching), VA (vertically aligned) or OCB (optical compensation birefringence). The latter is, for example, applying optical compensation film or other surface feature films. Because the improvement of inner liquid crystal boxes involves complicated process and most of the products still require the application of optical compensation film, it is therefore not popular. As for the improvement of outer liquid crystal boxes, it is widely used as an alternative solution because it is easier to utilize and does not interfere with the current process. Therefore, at present it is a widely applied improvement to the view angle.

Please refer to FIGS. 1A to 1F. Index of refraction for the optical anisotropy film is nx=ny=nz, wherein nx, ny and nz respectively stands for the index of refraction along the direction of x, y and z axe, respectively. Conventional optical compensation film are optically isotropic and divided into three groups according to the distribution pattern, A-plate, C-plate and biaxial. The A-plate retardation films have different index of refraction along x and y directions, i.e. (nx>ny=nz or nx<ny=nz, nx, ny and nz are index of refraction along the direction of x, y and z axe), as shown in FIGS. 1B and 1C. The C-plate optical compensation film have different index of refraction along x and z directions, i.e. (nx=ny>nz or nx=ny<nz, wherein nx, ny and nz are index of refraction along the direction of x, y and z axe), as shown in FIGS. 1D and 1E. The biaxial films have different index of refraction along all x, y and z directions (nx, ny, nz and nx>ny>nz), as shown in FIG. 1F, which parallel index of refraction, ne=nx−ny, and vertical index of refraction, nth=nx−nz are therefore defined.

Birefringence Δn, indicating the degree of refraction of light in different directions, is defined as light passes though isotropic retardation films and different refraction results are observed along different directions, such as Δn=nx−ny, Δn=ny−nz or Δn=nx−nz. If the Δn value becomes larger, the difference of refraction of light in two distinct directions will become larger, too. This is advantageous in LCD.

Conventional polymer films (such as TAC) are mostly stretched mono-axially or bi-axially to prepare isotropic retardation films. Referring to FIGS. 2A and 2B, although most chain-shaped polymers have respective unique optical anisotropy due to the asymmetric chemical structure, the polymer 21 is generally in amorphous state and the unique optical anisotropy, i.e. birefringence effect, is therefore invisible in macrostructure. After being mono-axially or bi-axially stretched, polymer 21 will come to a specific orientation arrangement and the optical isotropy among molecules is no longer mutually-cancelled so that the birefringence effect is again observed in macrostructure. The birefringence effect causes different refraction in different directions while light passes through, which can be used to change the light direction and useful in optical compensation film to correct the view angle.

TAC is this kind of polymer, which is often used in phase compensation device in the LCD recently. The TAC film is a film of positive optical birefringence (Δn) and has high optical isotropy, high birefringence, and high thermo-resistance. However, most TAC films are imported due to lack of core technology. Consequently, the cost of manufacturing orientation compensation device is excessively high and not ideal. There is a demanding need for economic and applicable optical film materials and its manufacture.

This invention was motivated by the above-mentioned driving force. The present invention provides a method for improving birefringence of optical films. An optical film of high birefringence can be prepared in accordance with a process of solution casting. The optical films are useful in phase compensation device of LCD.

### SUMMARY OF THE INVENTION

The present invention provides a method for improving the birefringence of an optical film in accordance with a process of solution casting to prepare an optical hybrid film of high birefringence, which is useful in phase compensation device in the LCD (liquid crystal display). One object of the present invention is to develop a hybrid material from a lower cost polymer by adding nano-particles to improve the birefringence of the hybrid material to be useful.

The present invention provides a method for improving the birefringence of an optical film. The birefringence is optionally positive or negative. The method prepares an optical hybrid film of high birefringence, which is useful in phase compensation device in a LCD, for improving the birefringence of an optical film in accordance with a process of solution casting. Another object of the present invention is to improve the birefringence of a conventional phase compensation device to facilitate the application.

The various objects, advantages and benefits of the present invention will become more apparent from the following detailed descriptions in conjunction with the appended drawings.

### BRIEF DESCRIPTION OF THE DRAWINGS

FIGS. 1A to 1F show the schematic drawings of index of refraction of various optical films.

FIG. 2A shows the molecular arrangement of a conventional polymer before it is stretched.

FIG. 2B shows the molecular arrangement of the conventional polymer after it is stretched.

FIG. 3 is the flow diagram of the process of the present invention.

FIG. 4A shows the molecular arrangement of the hybrid film of the present invention before it is stretched.

FIG. 4B shows the molecular arrangement of the hybrid film of the present invention after it is stretched.

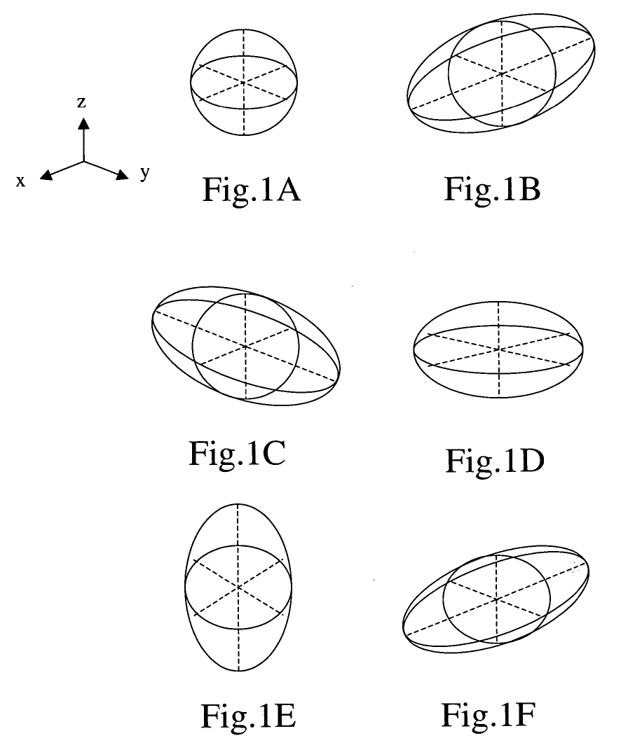

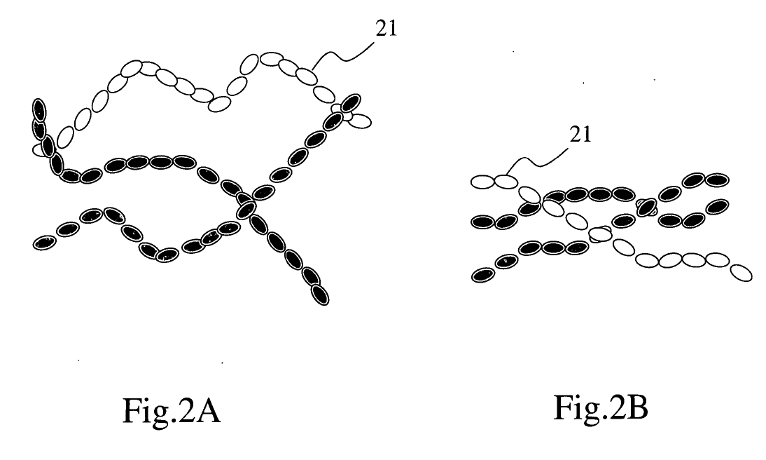

### DETAIL DESCRIPTION OF THE INVENTION

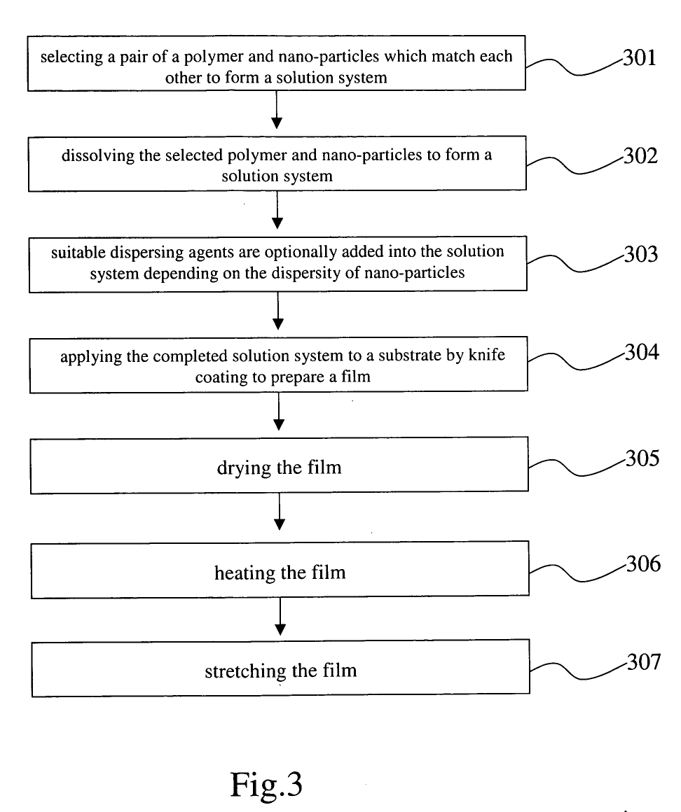

FIG. 3 is a flow diagram of the process of the present invention. The present invention prepares an optical film of high birefringence in accordance with solution casting. First, select a polymer and nano-particles which match each other and mix them up by means of solvate dissolving technique or fuse dispersing technique (such as solid cut dispersion, stretch fluid dispersion, static state dispersion, and dynamic dispersion) to form a solution system (step 301). Here, the solvent dissolving technique is taken for example. The suitable solvents may be ethyl acetate, toluene or THF. If it is positive birefringence to be improved, the polymer of positive birefringence may be AC (triactyl cellulose), PC (polycarbonate), PVA (polyvinyl alcohol), PES (polyether sulfone), PET (polyethylene terephthalate), COP (cyclic olefin polymer), COC (cyclic olefin copolymer) and goes with nano-particles of positive birefringence. If it is negative birefringence to be improved, the polymer of negative birefringence may be PMMA (polymethyl methacrylate), PS (polystyrene) and goes with nano-particles of negative birefringence with needle-like structure, such as SrCO₃ (strontium carbonate), BaCO₃ (barium carbonate) and CaCO₃ (calcium carbonate). Secondly, dissolve the selected polymer and nano-particles to form a solution system (step 302). Then, suitable dispersing agents are optionally added into the solution system depending on the dispersity of nano-particles (step 303) to avoid them conglomerating and jeopardizing the predetermined reaction of the solution system. In addition, step 303 may include adding of one or more auxiliaries. Apply the completed solution system to a substrate by knife coating to prepare a film (step 304). Dry the film (step 305) to remove the solvent from the system. After the film is formed, heat the film (step 306) to a temperature around the glass transformation temperature (T) then stretch the film (step 307) mono-axially or bi-axially. At last, depending on various stretch conditions, optical compensation film of different birefringence coefficient are accordingly prepared.

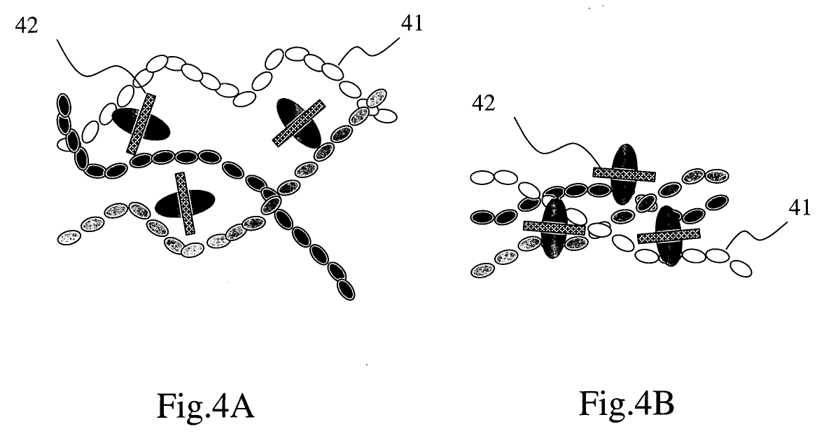

Referring to FIG. 4A and FIG. 4B, the present invention includes a polymer 41 (such as PMMA) and nano-particles 42 such as SrCO₃. After the reaction and film-forming steps, the polymer 41 and nano-particles 42 form a hybrid film (PMMA/SrCO₃). Before being stretched, the molecular arrangement is originally random. After being stretched (such x axis stretched), the polymer 41 and nano-particles 42 will align themselves. Besides, due to ellipse polarization, nano-particles 42 can increases the alignment of polarized light on the y axis, which enhances hybrid film birefringence value Δn (Δn=nx−ny). This shows that once the hybrid film is formed, the hybrid film can be stretched according to different requirements to obtain optical films of different birefringence and for use in phase compensation device in LCD.

The above is the description of the present invention. It is apparent that they are merely preferred embodiments. Any variations or modifications based on the gist of the present invention would be construed to be within the scope of the following claims.

1. A method of manufacturing an optical film in accordance with a solution casting process to improve optical film birefringence, comprising:
(1) selecting a pair of a polymer and nano-particles which match each other to form a solution system;
(2) applying said solution system to a substrate to form a thin film;
(3) drying said thin film;
(4) heating said thin film;
(5) stretching said thin film in accordance with different stretching conditions to prepare an optical film with different (corresponding?) birefringence index.

2. The method of claim 1, wherein the birefringence index to be improved comprises a optically positive one and a optically negative one.

3. The method of claim 2, wherein forming the solution system employs a technique selected from the group consisting of solvent dissolving technique and fuse dispersing technique.

4. The method of claim 1, wherein said step (1) further comprises adding a suitable dispersing agent to avoid said nano-particles conglomerating and decreasing the uniformity of the solution system.

5. The method of claim 1, wherein said step (1) further comprises modifying the surface of said nano-particles to avoid said nano-particles conglomerating and decreasing the uniformity of the solution system.

6. The method of claim 2, wherein the polymer in said step (1) is a polymer of negative birefringence for the negative one.

7. The method of claim 6, wherein the polymer of negative birefringence is selected from the group consisting of PMMA (polymethyl methacrylate) and PS.

8. The method of claim 6, wherein the nano-particles in said step (1) are nano-particles of negative birefringence for the negative one.

9. The method of claim 8, wherein the nano-particles of negative birefringence have a needle-like structure.

10. The method of claim 8, wherein the nano-particles of negative birefringence have a rod-like structure.

11. The method of claim 9, wherein the needle-like nano-particles of negative birefringence are selected from the group consisting of SrCO₃, BaCO₃ and CaCO₃.

12. The method of claim 3, wherein the solvent for use in the solvent dissolving technique is selected from the group consisting of ethyl acetate, toluene and THF.

13. The method of claim 2, wherein the polymer in said step (1) is a polymer of positive birefringence for the positive one.

14. The method of claim 13, wherein the polymer of positive birefringence is selected from the group consisting of TAC (triactyl cellulose), PC (polycarbonate), PVA (polyvinyl alcohol), PES (polyether sulfone), PET (polyethylene terephthalate), COP (cyclic lefin polymer) and COC (cyclic olefin oopolymer).

15. The method of claim 2, wherein the nano-particles in said step (1) are nano-particles of positive birefringence for the positive one.

16. The method of claim 1, wherein the stretching in said step (5) comprises monaxial stretching and biaxial stretching.
